(19) United States
(12) Patent Application Publication
(10) Pub. No.: US 2012/0043034 A1
(43) Pub. Date: Feb. 23, 2012

(54) Protective wall

(76) Inventor: Bernhard Feigl, Lochau (AT)

(21) Appl. No.: 13/199,026

(22) Filed: Aug. 17, 2011

(30) Foreign Application Priority Data
Aug. 19, 2010 (EP) 10173341.8

(51) Int. Cl. E06B 9/02

(52) U.S. Cl. 160/368.1

(57) ABSTRACT

A protective wall (1) releasably connectable to a floor (2), comprises panels (3), and a U-section rail (4) with legs (5, 6) running in parallel, and a web (7) arranged therebetween which grip the panels (3) and are locked thereon, the protective wall (1) being supported on the floor (2). A U-shaped holding pocket (11) is arranged on free ends of the legs (5, 6) of the U-section rail (4) and each pocket is arranged so one holding plate (12, 13) can be inserted into each of the holding pockets (11), and the holding plates (12, 13) are attached to a holding fixture (14) that is fixed onto the floor (2), and a holding groove (15) is provided on the outside of the web (7) of the U-section rail (4), and a locking body (16) is disposed in the holding groove (15), such that the locking body (16) is supported on the holding fixture (14) and is mounted so it can be moved in the horizontal direction relative to the holding fixture (14).

### BACKGROUND OF THE INVENTION

1. Field of the Invention

The invention relates to a protective wall releasably connectable to a floor.

2. Description of the Prior Art

A holding fixture for a glass panel of a balustrade is disclosed in EP 2194207 A1. The glass panel is inserted in a U-section and glued to it, with the effect that the glass panel and the U-section are firmly connected to one another at a factory, in order to be subsequently connected to a building floor by means of a holding fixture attached to the floor.

The balustrade serves in particular as a means of preventing falling from a balcony, stairs, or an intermediate floor in a building, with the effect that legally specified safety standards regarding the stability of the balustrade are complied with and, for one thing, a reliable protection against falling is achieved in case of high lateral loadings and, for another thing, the protection against falling is reliably provided on the intermediate floor or the balcony even after a certain service life, and will withstand loadings.

Furthermore, there is a groove provided on the outside of a web of the U-section rail and a setting plate is inserted in the groove. The setting plate is connected with a threaded pin which is held in a section attached to the intermediate floor as a holding fixture. The pin passes through a nut which is inserted in the section in a positionally oriented and rotationally fixed manner, with the effect that when the threaded pin is rotated, it is moved in the direction of the intermediate floor, or moved away from it, so that the holding plate thereby exerts a horizontal force on the underside of the section rail, as a result of which a vertical, i.e. perpendicular, setting of the entire balustrade is achieved.

The U-section rail has a U-shaped holding pocket which is hooked onto the holding fixture that is to be attached to the intermediate floor. Furthermore, the underside of the U-section rail lies on a housing which is firmly attached to the holding fixture, with the effect that the housing and the holding fixture support the balustrade in a vertical direction.

Designs of this kind have proven themselves in practice in balustrades as protection against falling, although they cannot be used for protective walls that are to be erected on a floor, because such balustrades require unobstructed access to an end face of the fixed floor, or wall, in order to support the U-section rail reliably on the floor by means of the holding fixture.

Furthermore, it has proven to be necessary for protective walls used, for example, for protecting against wind, driving rain or even sunshine in the area of terraces, to be installed and removed again quickly and in a straightforward manner.

### SUMMARY OF THE INVENTION

It is, therefore, a task of the present invention to create a protective wall of the aforementioned kind based on the balustrade of prior art which is, for one thing, reliably supported on a floor and (even given considerable wind loadings or other external loading situations), for another thing, can be installed and removed quickly and easily.

These purposes are achieved in accordance with the present invention.

The U-section rail, together with the panel inserted in it, can be pushed onto two holding plates running in parallel with one another and attached to a holding fixture, because a U-shaped and outwardly projecting holding pocket is formed onto each of the two free ends of a leg. The holding fixture, in turn, is connected to the floor in a releasable connection, although it is a connection which is firm when it is attached, with the effect that the holding fixture, and thereby the holding plates, reliably support the U-section rail and the panel inserted in it on the floor. The holding fixture can be attached to the floor quickly and easily and/or the U-section rail can be disconnected from the holding fixture, which means that the installation or removal of the panels can be performed quickly by users who do not require any specialist training or knowledge in order to do this.

Moreover, it is a particularly advantageous feature that the U-section rail possesses a holding groove on the outside of the web and a locking body engages in the holding groove, with the locking body being mounted in a vertical direction on the holding fixture and movable in a horizontal direction in relation to the holding fixture. By this means, for example by moving the locking body, it is possible to align the panel perpendicularly in parallel with the surface of the floor. Straightforward installation tools, such as a screwdriver, can be used for this purpose.

In order to provide additional support for the holding fixture on the floor, it is possible to insert a stabilisation plate between the holding fixture and the floor, in which case the stabilisation plate projects beyond the outer contour of the holding fixture with the effect that objects, such as flower tubs and concrete slabs, can be placed on the stabilisation plate in order to increase the load.

Stabilisation of the holding fixture is increased in an advantageous manner in particular in that a web is provided between the upper holding plate inserted in the holding pocket of the U-section rail and the legs of the holding fixture running parallel to the floor, with the effect that the holding fixture together with the holding plate have a triangular cross-sectional contour. In case of particularly high loadings, such as between housings in which there can be flows of air from both sides, the web is also formed onto the second holding plate so that the holding plates, together with the holding fixture, form a triangular cross-sectional contour in each case. As a result, the holding plates are additionally supported on each of their outer sides by means of the web on the holding fixture.

In order to increase the stability and the stiffness of the two holding plates, as well as to lock adjacent U-section rails, plate-shaped connecting elements are provided which can be pushed in sideways between two holding lugs arranged flush with one another on each U-section rail. As a result, two U-section rails can be assembled in alignment with one another or for forming a corner by means of the connecting elements.

### BRIEF DESCRIPTION OF THE DRAWINGS

The drawings show three sample embodiments in accordance with the present invention, in a sectional view in each case, the details of which are explained below. In detail:

FIG. 1 is a sectional view showing a first illustrative embodiment of a protective wall with a U-section rail and with a holding fixture which comprises two substantially mirror-image triangular cross-sectional contours,

FIG. 2 is a sectional view showing a second embodiment of a protective wall with a U-section rail and with a triangular holding fixture on one side, and

FIG. 3 is a sectional view showing a protective wall with a U-section rail and with a double-sided cross-sectional contour, in a triangular configuration of the holding fixture, in which the panel is held in the U-section rail by means of one or more screws.

### DESCRIPTION OF THE PREFERRED EMBODIMENTS

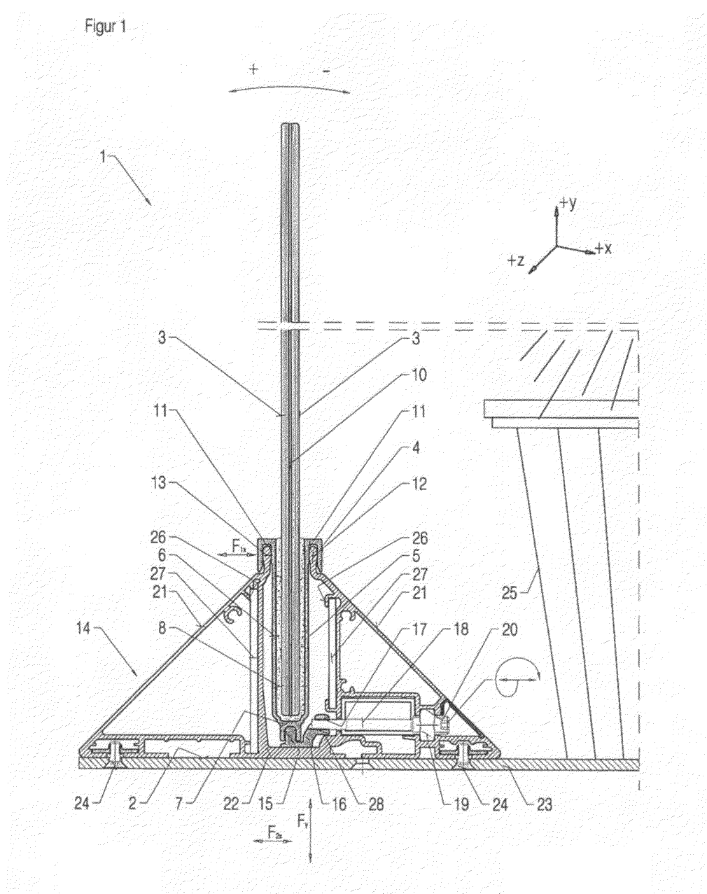

FIG. 1 shows a protective wall 1 by means of which drafts should be prevented in the area of terraces in particular, in order to protect people against drafts, for example. The protective wall 1 is mounted on a floor 2 by means of a holding fixture 14 explained in more detail below, with the effect that the protective wall 1 can withstand loadings caused by the effect of wind force and does not fall over as a result. Furthermore, the protective wall 1 should be able to be installed in and removed from the holding fixture 14 again as quickly and easily as possible, in order to allow it to be protected from frost and other damage during winter months, by keeping it in storage rooms.

The protective wall 1 consists of a U-section rail 4 in which, in the illustrated embodiment, two panels 3 are firmly installed at the factory by means of a layer of glue 8. The two panels are secured together by a foil 10 in order to form a pane of safety glass. This means the panels 3 and the U-section rail 4 form a single assembly which, as has been mentioned, can be released from the holding fixture 14, or connected to it, as quickly and as easily as possible.

This is achieved in that a U-shaped holding pocket 11 is formed on each U-section rail 4, specifically on two legs 5 and 6 projecting outwards, and the opening in the pocket 11 runs parallel to the panels 3. The holding fixture 14 consists of two holding plates 12 and 13 running parallel to one another and to the panels 3. The two holding plates 12 and 13 are attached to a common support plate 22 at their bottom end facing the floor 2. The support plate is connected to the floor 2 by means of mounting screws 24, with the effect that the plates 12 and 13 forming the holding fixture 14, as well as the support plate 22, are firmly attached to the floor 2.

The holding pockets 11 of the U-section rail 4 can accordingly be hooked onto the two holding plates 12 and 13, with the effect that these run along an identical height level. The holding pockets 11 are formed onto the U-section rail 4 corresponding to the alignment of the holding plates 12 and 13. It is also possible, without further trouble, for the holding pockets 11 to be arranged on different height levels, if the two holding plates 12 and 13 are on different heights due to local conditions.

If possible, there should not be an air gap between the two vertical legs of the holding pocket 11 and the outside/inside of the corresponding holding plate 12 or 13, in order to support horizontal loadings in the X-direction in accordance with the indicated system of coordinates. The end surfaces of the holding plates 12 and 13 projecting freely upwards are, however, not in contact with the inside of the holding pocket 11; rather, there should be an air gap between the holding pocket 11 and free ends of the holding plates 12 and 13. This is because vertical loads should not be transferred through the holding pocket 11 onto the holding plates 12 and 13. Also, the air gap is necessary between the free leg of the corresponding holding pocket 11 and the outside of the holding plate 12 or 13, in order to exclude any force transmission in this area.

The U-section rail 4 consists of the two legs 5 and 6 running in parallel with one another, which are aligned in parallel with the panel 3. A web 7 of the U-section rail 4, which connects the legs 5 and 6, is arranged in between them. A holding groove 15 is formed on the outside of the web 7, with the cross-sectional contour of the groove 15 having a U-shape. The holding groove 15 attached to the web 7 is intended to absorb both vertically and horizontally acting forces and transmit them to the holding fixture 14.

For this purpose, there is a locking body 16 inserted in the holding groove 15, the cross section of which locking body 16 is principally configured in an L-shape. A block 28 is formed onto one leg of the locking body 16 and is inserted into the holding groove 15. An air gap is provided between the upper side of the block 28 and the inside of the holding groove 15. The two legs forming the holding groove 15 run along the side adjacent to the block 28 and are in contact with it, thereby allowing horizontal forces to be transferred in the X-direction. Furthermore, the free end surfaces of the legs of the holding groove 15 are supported on the surface of the locking body 16, with the effect that the vertical forces, i.e. loadings vectored in the Y-direction, are transferred onto the locking body 16 by means of the end faces of the holding groove 15.

The locking body 16 is in contact with the support plate 22 of the holding fixture 14 and can be moved relative to it in the Y-direction. In order to carry the vertical forces from the locking body 16 to the holding fixture 14, there is a holding opening 17 worked into the locking body 16 and a threaded rod 18 is inserted in the opening 17 in a rotationally fixed and positionally oriented manner. The threaded rod 18 runs in parallel with the floor 2; it can be accessed from externally. In the outer area of the holding fixture 14, there is a nut 19 screwed onto the threaded rod 18 and the nut 19 is supported in a rotationally fixed and positionally oriented manner in a pocket 20 worked into the holding fixture 14. The drawings show that the threaded rod 18 can be rotated about its lengthways axis. As soon as the threaded rod 18 is screwed in, for example in the direction of the panel 3, the threaded rod 18 presses the locking body 16 away from the nut 19; the distance between the nut 19 and the block 28 is consequently increased. This means that the panel 3 is tilted to the right. If, on the other hand, the threaded rod 18 is screwed in the opposite direction into the nut 19, the locking body 16 is pulled towards the nut 19, with the effect that the distance between the block 28 and the nut 19 is reduced and the panel 3 is tilted to the left. This adjustment feature means that the panel 3 can be aligned vertically, for example, in order to compensate for tolerances in manufacture.

A stabilisation web 21 is provided between the two holding plates 12 and 13 running in the area of the holding pocket 11 and the support plate 22 of the holding fixture 14. Accordingly, the holding plates 12 and 13 form a triangular cross-sectional contour together with the stabilisation web 21 and the support plate 22, by means of which the torsional rigidity of the holding fixture 14 is increased, with the effect that the holding plates 12 and 13 are reliably held in position, even in case of vertical loadings, such as due to wind load.

In order to improve the stability of the holding fixture 14 further, holding lugs 26 spaced apart from one another are arranged on each of the holding plates 12 and 13, between which lugs 26 a connecting element 27 with a plate-shaped configuration can be inserted. If the connecting element 27 is inserted in the holding lugs 26 in a positionally fixed arrangement, the wall thickness of the holding plates 12 or 13 is increased by the wall thickness of the connecting elements 27, with the effect that stabilising effects are provided.

Furthermore, the connecting elements 27 project beyond the U-section rail 4, with the effect that another U-section rail 4 can be attached for extending the entire protective wall 1 by means of the two connecting elements, in such a way that the two adjacent U-section rails 4 can be flush-fixed. The connecting elements 27 can also be bent to a specified angle, with the effect that two adjacent U-section rails 4 can be locked together at an angle, such as 90°, by means of the two connecting elements 27.

Often, it is difficult to support the holding fixture 14 reliably on the leg 6, therefore a stabilisation plate 23 is provided to improve the effective connection between the holding fixture 14 and the floor 2, in which case the plate 23 can be attached to the support plate 22 of the holding fixture 14 by means of mounting screws 24. The stabilisation plate 23 projects beyond the holding fixture 14 in this case, with the result that objects, for example flower tubs 25, can be placed on this projecting area of the stabilisation plate 23. The weight of the flower tubs 25, or concrete slabs, or the like, means that the holding fixture is supported in its lateral area, with the effect that the stability of the protective wall 1 can also be increased by this measure.

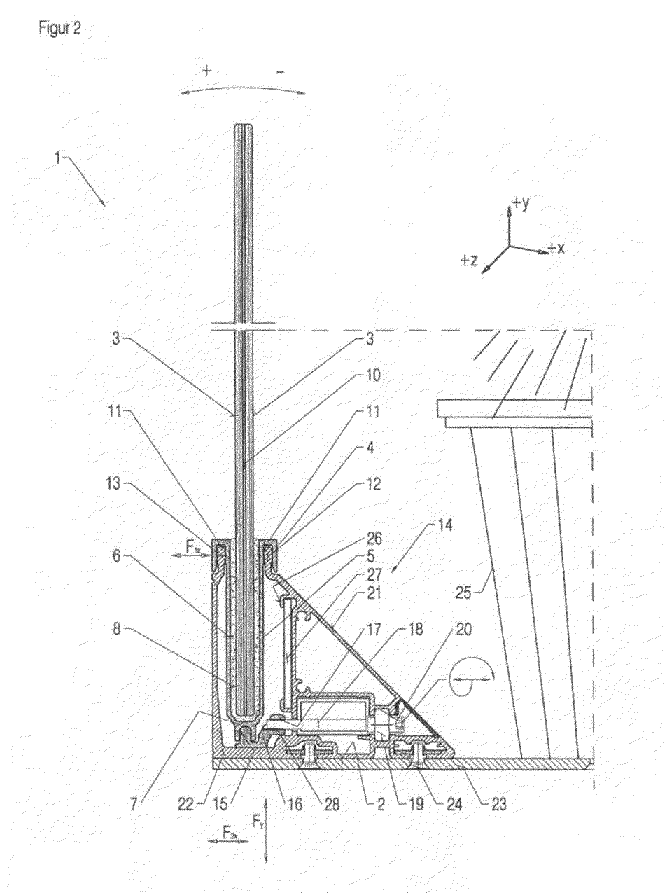

FIG. 2 shows the holding fixture 14 configured in such a way that it only has the stabilisation web 21 between the holding plate 12 and the support plate 22. The adjacent holding plate 13 is directly and exclusively attached to the support plate 22.

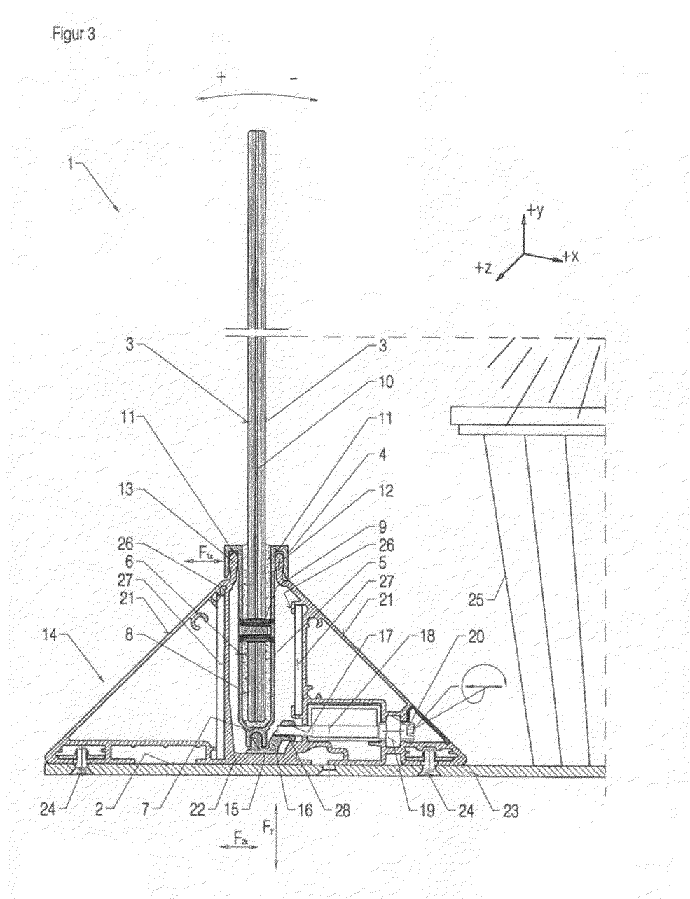

FIG. 3 shows the panel 3 firmly connected to the U-section rail 4 by means of a plurality of screws 9.

1. A protective wall (1) connectable to a floor (2) in a releasable arrangement, the wall comprising one or more panels (3) forming a surface, and a U-section rail (4) with two legs (5, 6) running in parallel and a web (7) arranged therebetween and which grip the panel (3) and are locked thereto,
wherein
a U-shaped holding pocket (11) is arranged on both free ends of each of the legs (5, 6) of the U-section rail (4) and each holding pocket is arranged in relation to one another so that one holding plate (12) and another holding plate (13) running parallel to it, can be inserted into each of the holding pockets (11), the two holding plates (12, 13) being attached to a holding fixture (14) that is fixed onto the floor (2), a holding groove (15) provided on the outside of the web (7) of the U-section rail (4), and a locking body (16) inserted into the holding groove (15) and supported on the holding fixture (14) in a vertical direction is mounted so it is moveable in a horizontal direction relative to the holding fixture (14).

2. The protective wall in accordance with claim 1,
wherein
the locking body (16) has an L-shaped cross section with a block (28) projecting in the direction of the holding groove (15) formed therein, and the outside contour of the block is adapted to the inside contour of the holding groove (15) and makes contact therewith in a horizontal direction.

3. The protective wall in accordance with claim 2,
wherein
the two free ends of the holding groove (15) on a side next to the block (28) make contact with a leg of the locking body (16) in order to support vertical loadings.

4. The protective wall in accordance with claim 2,
wherein
a holding opening (17) is worked into the locking body (16) and a threaded rod (18) inserted therein runs parallel with the floor (2), and the threaded rod (18) passes through a nut (19) at an end opposite to the locking body (16), and the nut (19) is supported on the holding fixture (14) in a rotationally fixed and positionally oriented manner.

5. The protective wall in accordance with claim 1,
wherein
the holding fixture (14) is configured with a triangular or rectangular cross section.

6. The protective wall in accordance with claim 1,
wherein
a stabilisation web (21) is arranged between a free end of the holding plate (12 or 12 and 13) facing outwards and aligned in parallel with the panel (3) and a support plate (22) of the holding fixture (14) running parallel to the floor (2).

7. The protective wall in accordance with claim 6,
wherein
a stabilisation plate (23) is arranged between the holding fixture (14) and the floor (2), and is attached to the holding fixture (14) by mounting screws (24).

8. The protective wall in accordance with claim 7,
wherein
the stabilisation plate (23) projects beyond the holding fixture (14) on at least one side of the holding fixture (14), for receiving objects, such as flower tubs (25), concrete slabs, and the like, on the stabilisation plate.

9. The protective wall in accordance with claim 1,
wherein
the panels (3) forming the protective wall (1) are locked in the U-section rail (4) by a selected one of screws (9) and glue (8).

10. The protective wall in accordance with claim 1,
wherein
each of the two holding plates (12, 13) is provided with two holding lugs (26) formed thereon which are located flush with one another and spaced apart, and a connecting element (27) is insertable between two adjacent holding lugs (26) of the holding plates (12, 13).

11. The protective wall in accordance with claim 10,
wherein
the connecting element (27) in an area between the holding lugs (26) makes face contact with the holding plate (12 or 13) or extends a distance from the holding plate, and the connecting element (27) locks the first U-section rail (4) onto a second U-section rail (4) in a flush or angled arrangement.

12. The protective wall in accordance with claim 1,
wherein
the holding fixture (14) supports a plurality of the panels (3) which are spaced apart from one other in such a way as jointly to form the protective wall (1).

13. A holding fixture (14) for supporting at least one panel (3) on a floor (2), for forming a protective wall (1), the holding fixture comprising a U-section rail (4) attached to the panel (3),
wherein
an outwardly projecting holding pocket (11) is formed onto each of two legs (5 and 6) of the U-section rail (4) aligned in parallel with the panel (3), with the holding pockets (11) being open downwards in the direction of the floor (2), and the holding fixture (14) is formed from two holding plates (12 and 13) running in parallel with one another which are formed on a support plate (22) such that the U-section rail (4) is insertable between the two holding plates (12 and 13), and the holding pocket (11) of the U-section rail (4) is hooked onto two free ends of the holding plates (12 and 13).

14. The holding fixture in accordance with claim 13,
wherein
a holding groove (15) with a U-shaped inside contour is attached to a web (7) of the U-section rail (4) running in parallel with the floor (2), a locking body (16) is inserted into the holding groove (15), and the locking body (16) runs parallel with the floor (2), the fixture being mounted so it can be moved in relation to the support plate (22) and has a block (28) formed onto it and which is insertable into the holding pocket (11).

15. The holding fixture in accordance with claim 14,
wherein
the locking body (16) is supported in a vertical direction on the support plate (22), and a holding opening (17) is worked into the locking body (16) and a threaded rod (18) insertable into the opening in a positionally oriented manner, the thread (18) being accessed from the outside and screwed into a nut (19) which is held in a rotationally fixed and positionally oriented manner in a pocket (20) worked into the holding fixture (14).
